(19) United States
(12) Patent Application Publication
(10) Pub. No.: US 2008/0300929 A1
(43) Pub. Date: Dec. 4, 2008

(54) SYSTEM AND METHOD FOR EVOLUTIONARY LEARNING OF BEST-OF-BREED BUSINESS PROCESSES

(76) Inventors: Biplav Srivastava, Noida (IN); Vandana Srivastava, Noida (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/754,459

(22) Filed: May 29, 2007

(51) Int. Cl. G06F 17/50

(52) U.S. Cl. 705/7

(57) ABSTRACT

A method of evaluating business processes comprises inputting a set of initial processes, inputting a distance function, and determining whether new processes are allowed. If such new processes are not allowed, the method determines which of the initial processes is the best process by applying the initial processes to the distance function to determine which of the initial processes has the lowest measure score produced by the distance function. Therefore, the method identifies the initial process having the lowest measure score as the best-of-breed process. If such new processes are allowed, the method determines which of the initial processes and the new processes is the best using the following process. The process of finding the best process translates the initial processes to counterparts for use with an evolutionary algorithm and selects a fitness function for the evolutionary algorithm. This process continues by applying the evolutionary algorithm to the counterparts using the fitness function to generate an output state (score) and determining which of the processes is closest to the output state to identify the best process. Then the best-of-breed process can be translated and output to the user.

### BACKGROUND AND SUMMARY

The embodiments of the invention generally relate to learning best-of-breed business processes, and, more particularly, to a method that finds best-of-breed processes which may or may not be within a given process set.

The problem of finding a best-of-breed process is very important. In plain terms, finding the best-of-breed process means that for a given task and many ways of doing the same task (all of which may not be known), how does one determine what is the best process (i.e., detailed steps) for doing it given that scenarios change over time. Today, only subjective bases for best-of-breed process exist and there are no well defined metrics. Yet, there may be a need to ensure that the processes followed are the best possible within existing business constraints. Moreover, it may not be necessary that the best-possible process is among the currently known or practiced processes.

For example, let us take the case of Information Technology (IT) management and its service delivery. To make IT management practices more standardized, repeatable, and amenable to analysis, IT Infrastructure Library (ITIL) has formalized a set of system management processes. These define best practices and help bring structure to the system administration processes. A key set of ITIL processes include incident management, change management, problem management, release management, configuration management, performance management, and service continuity. Among them, Change Management seeks to control and reduce the risk of any alteration made to an IT infrastructure in its hardware, software or attached network. Now, if one were to make a software change to a Windows server, one would use Windows Server Change Management process. The question would be: how does an outsourcing provider for IT management services determine the best-of-breed Change Management process for these and other types of changes that may be followed in one of its centers or even be unknown to it?

As another set of examples, suppose one desires to know which cooking (of the same food) at two restaurants is better; whether booking of travel by two agencies, or by self-help is better; etc. The present invention provides methods to answer this, even if the better process is not one among the given set.

This disclosure presents a system and method to determine the best-of-breed process among an existing set of processes under different interpretations. The invention also provides a method to find a best-of-breed process which may not be in the given set. So, the tool can be run on a continuing basis to ensure that the currently running process is the best-of-breed. The inventive tool comprises a process assessment tool which takes in a set of processes and the criteria to judge best-of-breed property. The tool determines whether one of the processes is a best-of-breed (BOB) process. If not, it searches to find one.

Thus, in one embodiment, the method of evaluating business processes comprises inputting a set of initial processes, inputting a distance function, and determining whether new processes are allowed. If such new processes are not allowed, the method determines which of the initial processes is the best process by applying the initial processes to the distance function to determine which of the initial processes has the lowest measure score produced by the distance function. Therefore, the method identifies the initial process having the lowest measure score as the best-of-breed process.

Now provided is a standard technique called Evolutionary Algorithm (EA) and its specific type called Genetic Algorithm (GA), which we will use in producing processes that are not even available in the input set. Evolutionary algorithm (EA) refers to a family of generic population-based optimization algorithm which considers possible solutions as populations and uses operators inspired by biological evolution like reproduction, mutation, recombination and survival of the fittest, to find better solutions. More information on EA is available at wikipedia.org/wiki/Evolutionary_algorithm.

The invention uses Genetic Algorithm (GA), an exemplary type of EA. GA defines well-understood notions of mutation, selection, and crossover (also called recombination) operators and for our problem, any standard notion will work. In a given problem, one can use genetic algorithm by defining two major inputs: a genetic representation of the solution domain and a fitness function to evaluate the solution domain.

The pseudo-code of GA is:
Choose initial population
Evaluate the fitness of each individual in the population
Repeat
   Select best-ranking individuals to reproduce
   Breed new generation through crossover and mutation (genetic operations) and give birth to offspring
   Evaluate the individual fitnesses of the offspring
   Replace worst ranked part of population with offspring
Until terminating condition(s) are met
   More details on GA can be found at wikipedia.org/wiki/Genetic_algorithm.

If new processes are allowed to be found, our method determines which of the initial processes and the new processes are the best using the following process. The process of finding the best process translates the initial processes to counterparts for use with an evolutionary algorithm like Genetic Algorithm (GA) and selects a fitness function for the algorithm. This process continues by applying the evolutionary algorithm (methodology) to the counterparts using the fitness function to generate an output state (score) and determines which of the processes is closest to the output state to identify the best process. Then the best-of-breed process can be translated and output to the user.

Another similar embodiment inputs the set of initial processes, a metric vector, and historical data. This embodiment also determines whether new processes are allowed. If such new processes are not allowed, the method determines which of the initial processes is the best process by applying the initial processes to the metric vector and the historical data to determine which of the initial processes has a highest metric score. The method identifies the initial process having the highest metric score as the best-of-breed process.

However, if the new processes are allowed, this embodiment determines which of the initial processes and the new processes is the best process by again translating the initial processes to counterparts for use with the evolutionary algorithm. This aspect of the method selects a fitness function for the evolutionary algorithm and applies the evolutionary algorithm to the counterparts using the fitness function to generate an output state (score). Then, this process determines which of the processes is closest to the output state to identify the best process, and again translates and outputs the best process.

Advantages of the invention include that it uses data to learn best-of-breed process, the metrics and basis become explicit, the best-of-breed can be determined without metrics (based on distance function between processes), and the assessment evolves with ongoing performance.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a schematic diagram of distance measures;

FIG. 2 is a flow diagram illustrating a method embodiment of the invention; and

FIG. 3 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, the embodiments of the invention generally relate to learning best-of-breed business processes, and, more particularly, to a method that finds best-of-breed processes which may or may not be within a given process set. This disclosure presents a system and method to determine the best-of-breed process among an existing set of processes under different interpretations. The invention also provides a method to find a best-of-breed process which may not be in the given set. The tool can be run on a continuing basis to ensure that the currently running process is the best-of-breed. The inventive tool comprises a process assessment tool which takes in a set of processes and the criteria to judge best-of-breed property. The tool determines whether one of the processes is a best-of-breed (BOB) process. If not, it can search to find one.

For example, the evolutionary learning of best-of-breed processes can be seen by looking at windows server change management. The pain point addressed in such a system is very high because only subjective bases for best-of-breed process exist, and there are no well defined metrics. Yet, there is a need to ensure that the processes followed are the best possible within existing business constraints.

Solutions include the building of a business process evolution testbed on a modeling tool (e.g., WBI Modeler). Further, competing business processes and their historical delivery data can be obtained from reports. Modeling of important business process steps and their necessary constraints can also be performed. Evolutionary algorithms can be used (e.g., genetic programming) to generate variants and historical data can be used to predict variants performance. Input processes and newly generated possibilities can be scored and significantly advantageous business processes can be identified.

The benefits produced include the use of data to learn best-of-breed process, the metrics and basis become explicit, and the process would evolves with ongoing performance. Further, the embodiments herein are relevant for all processes.

In conventional systems, there is no basis to judge any generic process as best-of-breed. Embodiments herein can use a metric vector M and various interpretations to judge a process as the best-of-breed. One point of difficulty is agreeing to one M for a process. The embodiments herein can perform multiple interpretations (distance summary and highest score) with or without M. Because the best-of-breed process may not be an existing one, the embodiments herein can search through the space of possible configurations for a better fitness (best-of-breed) characteristic.

With respect to information processing occurring at a process (activity done by a performer), a process step consumes information about input, does processing and produces output. The information output records that the process has taken place. If a process has I inputs, O outputs and T internal state information artifacts/variables, assuming that a process step manipulates 1 or more state variables, a processes step produces a maximum of 1 output variable (i.e., 1 LHS). Null processes, with no inputs and outputs, are omitted or handled separately. Thus, the process will have a minimum of |O| process steps and a maximum of |I|+|O|+|T| process steps.

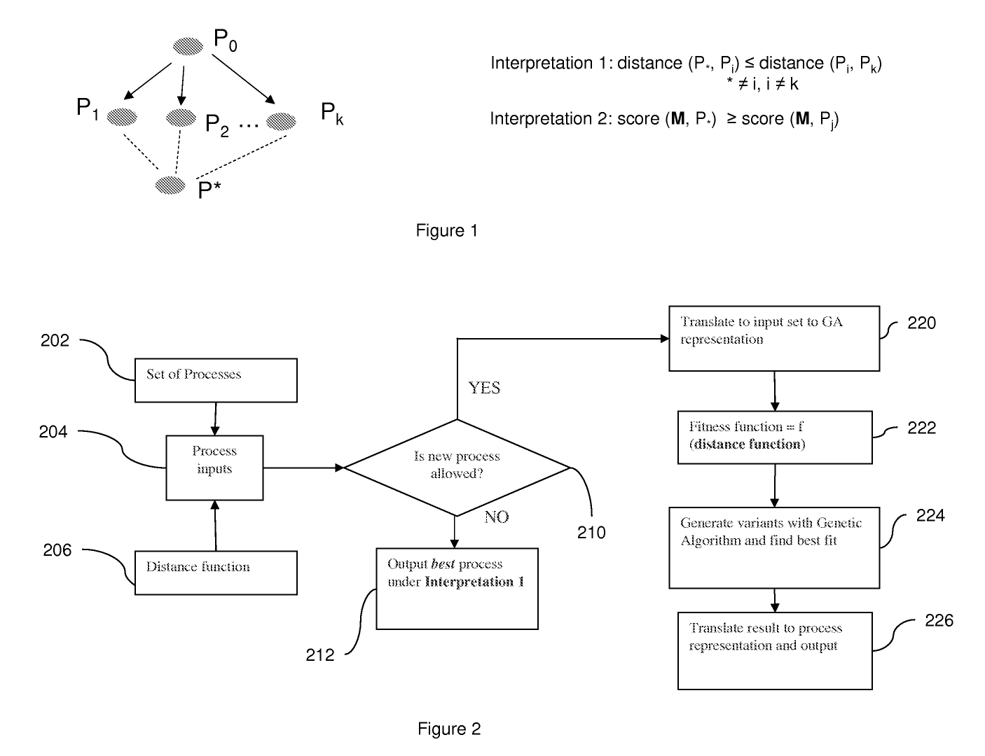

As shown in FIG. 1, let a business process (like server change management or cooking a specific dish) be defined in the beginning and be represented by P0. Suppose P0 is now followed in k different places. Let the process be called P1 . . . Pk. What we want to determine at a time-point is the best-of-breed process P* among the k business process instances of the original process. Now what we mean by best can be subject to many interpretations. We give two interpretations; interpretation 1: where distance (P*, Pi)<distance (Pi, Pk), *≠i, i≠k; and interpretation 2: where score (M, P*)>score (M, Pj). In interpretation 1, P* is the generalized summary of P1 . . . Pk in the sense that it is closest to any other process in the set. In interpretation 2, with respect to some metrics M, P* is a process which does the same processing but has the best score compared to P1 . . . Pk.

With respect to a first exemplary problem (Problem 1) it is desired to find which process is the best-of-breed among P1 . . . Pk. In interpretation 1: P*=arg minimum (i) {Sum [distance (Pi, Pk)]}. In interpretation 2: P*=arg maximum (i) {score (M, Pi)}.

With respect to a second exemplary problem (Problem 2) it is desired to find the best-of-breed process P* regardless of whether it is being practiced or not (i.e., P* is not necessary to be from P1 . . . Pk ). The method generates all possible process variants (the search space) and uses the interpretations functions to find the best-of-breed process.

In one embodiment shown in FIG. 2, the method of evaluating business processes comprises inputting a set of initial processes 202 and inputting a distance function 206 to provide process inputs 204. In item 210, the method determines whether new processes other than from P1 . . . Pk are allowed. If such new processes are not allowed, processing proceeds to item 212 where the method determines which of the initial processes is the best process by applying the initial processes to the distance function to determine which of the initial processes has the lowest measure score produced by the distance function. Therefore, the method identifies the initial process having the lowest summed measure score as the best-of-breed process.

However, if such new processes are allowed, processing proceeds to items 220-226 where the method determines which of the initial processes and the new processes is the best. More specifically, in item 220, the process of finding the best process translates the initial processes to counterparts for use with a Genetic Algorithm (GA). Next, in item 222, the method identifies and selects a fitness function for the Genetic Algorithm (the distance function in this example). This process continues by applying GA to the counterparts using the fitness function to generate variants and find a best fit (item 224). In item 224, the GA provides an output state (score) and the method determines which of the processes is closest to the output state to identify the best process. Then the best-of-breed process can be translated and output to the user in item 226.

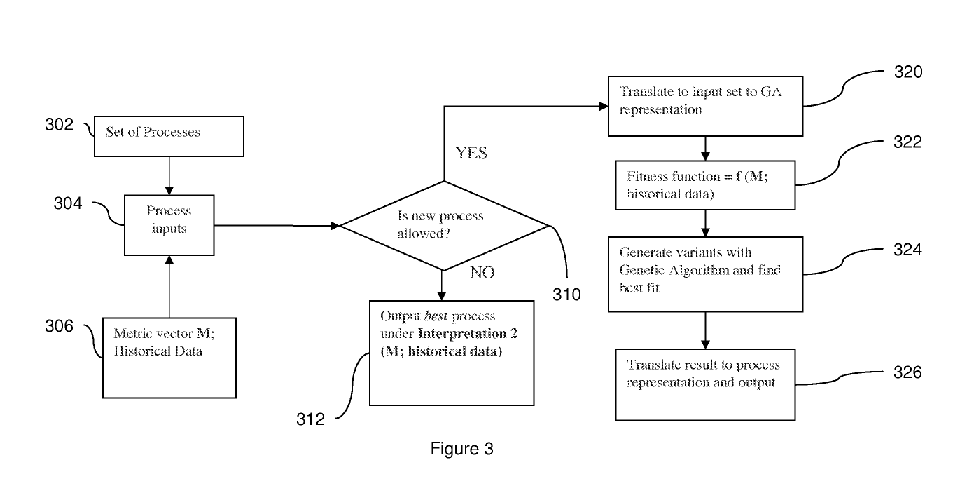

Another similar embodiment is shown in FIG. 3. In item 302, the method inputs the set of initial processes 302; and a metric vector and historical data 306 as process inputs 304. This embodiment also determines whether new processes are allowed in item 310. If such new processes are not allowed, processing proceeds to item 312 where the method determines which of the initial processes is the best process by applying the initial processes to the metric vector and the historical data to determine which of the initial processes has a highest metric score. The method identifies the initial process having the highest metric score as the best-of-breed process.

However, if the new processes are allowed, this embodiment proceeds to items 320-326 to determine which of the initial processes and the new processes is the best process. Item 320 again represents the translating of the initial processes to counterparts for use with the GA. Item 322 selects a fitness function for the GA and item 324 applies the GA to the counterparts using the fitness function to generate variants and an output state (score) to find the best fit. Item 324 determines which of the processes is closest to the output state to identify the best process. Item 326 again translates and outputs the best-of-breed process.

There are reasons for modifications in a business process (sources of variability). For example, process steps can be merged, a process step can be disintegrated into multiple steps, process steps can be re-arranged, while still maintaining the dependency constraints (e.g., data flow), etc.

With respect to the GA, the population is the search space representation, children operators include cross-over and mutation. For processes, the population is a set of sets (the steps in the process and the data variables manipulated at each step of the process). For the children operators, the cross-over includes steps crossed between parents, which may have different data variables being manipulated in the individual steps, but the total variables will be the same (e.g. Parent 1: {{v1, v2} {v3, v4} {v5}}; Parent 2: {{v1} {v2, v3, v4} {v5}} after cross-over, Child 1: {{v1} {v2, v3, v4} {v5}}; Child 2: {{v1, v2} {v3, v4} {v5}}). With respect to mutation, data variables in a process step are added or deleted, with or without a process step (e.g., Parent: {{v1, V2} {v3, v4}}; Child: {{v1}{v2} {v3, v4}}). Also, in this case the fitness measure is the metric M.

Thus the GA takes processes P1 . . . Pk. This methodology lets Q1 . . . Qk be the counterpart of the processes in the population representation. The method selects an interpretation to be used for fitness function (distance or M). The algorithm selects distance function if interpretation 1 is used and selects M if interpretation 2 is used (along with historical data). The evolutionary algorithm (algorithm) is run with the initial population (Q1 . . . Qk). This description lets Q* be the resultant state when the GA ends. The P* corresponding to Q* is the best-of-breed process. Under interpretation 2, score (P*, M) is the best possible score and identifies the best-of-breed.

The metric M comprises two components, an effectiveness measure and an efficiency measure. The effectiveness measure is, for example, what the customer sees and the efficiency measure is what the delivery organization sees. Some common effectiveness measures are customer satisfaction, cycle time, and price. Some common efficiency measures are cost, time taken and profitability. One could use these example metrics or a combination of them, as well as consider other metrics.

Thus, metrics could determine which of the following is better: Process 1: book flight, book hotel, book car, or Process 2: book car, book hotel, book flight. Both could be the same on effectiveness measure, and thus, both would give the same effectiveness result. However, the two processes could be different on efficiency measures. For example, the initial outputs of Process 1 could be more robust to changes during itinerary building process (not making car booking will rarely upset an itinerary, but choosing flights last can be a show stopper to any itinerary). Similarly, flights are limited and costly, while cars are plentiful and inexpensive. Other issues with respect to effectiveness include the quality of the output (price of the itinerary, number of stopovers, start and end time) as well as the time taken to execute the process. With respect to efficiency, other issues include redundant data manipulations on variables in a process step, redundant process steps (cycles), the length of the process (against benchmark), the time taken to execute the process, and the stability of the process outputs throughout processing. The embodiments help make the best selection among the processes, as shown above in FIGS. 2 and 3.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

1-3. (canceled)

4. A method of evaluating business processes comprising:
inputting a set of initial processes;
inputting a metric vector;
inputting historical data;
determining whether new processes are allowed;
if said new processes are not allowed, determining which of said initial processes is a best process by applying said initial processes to said metric vector and said historical data to determine which of said initial processes has a highest metric score, and identifying said initial process having said highest metric score as said best process;
if said new processes are allowed, determining which of said initial processes and said new processes is a best process by:
translating said initial processes to counterparts for use with an evolutionary algorithm;
selecting a fitness function for said evolutionary algorithm;
applying said evolutionary algorithm to said counterparts using said fitness function to generate an output state;
determining which of said processes is closest to said output state to identify said best process; and
outputting said best process,
wherein said fitness function comprises said metric vector and said historical data, and
wherein said evolutionary algorithm creates children operators.

5-6. (canceled)
